(19) United States
(12) Patent Application Publication
(10) Pub. No.: US 2013/0033364 A1
(43) Pub. Date: Feb. 7, 2013

(54) EVENT DRIVEN CONTEXT SWITCHING IN PASSIVE RADIO FREQUENCY IDENTIFICATION TAGS

(71) Applicants: Shimi Raz, Bat Hefer (IL); Guy Hayo, Bat Hefer (IL)

(72) Inventors: Shimi Raz, Bat Hefer (IL); Guy Hayo, Bat Hefer (IL)

(73) Assignee: R.F KEEPER LTD, Rosh Ha'ain (IL)

(21) Appl. No.: 13/641,907

(22) PCT Filed: Apr. 17, 2011
(86) PCT No.: PCT/IL2011/000323

§ 371 Date: Oct. 22, 2012

Related U.S. Application Data
(60) Provisional application No. 61/326,702, filed on Apr. 22, 2010.

(51) Int. Cl. G06K 7/01; G06K 19/073

(52) U.S. Cl. 340/10.1; 235/492

(57) ABSTRACT

The invention relates to an event driven content switching technology in a passive, batteryless radio frequency identification (RFID) tag. The RFID tag device monitors the occurence of an external event such as a change in the environment. The switching of the context of the tag is effected by sensors incorporated in the tag. An external event triggers the switch. An RFID reader may subsequently read out the occurrence of the event due to the switch change. Different alignments of the switch could bring about the closing or opening of specific electronic circuits within the RFID tag that effect the storing of information in a selected memory, or changing the ID transmitted by the tag. In a particular embodiment this latter is accomplished by shorting one or the other of two RFID tag antennas. When one antenna is shorted, the second tag's ID is sent, and vice versa.

### FIELD OF THE INVENTION

The invention relates to radio frequency identification (RFID) tags in general, and more particularly to a passive, battery-less, RFID tag provided with sensing capabilities and the ability to store sensed data and transmit it to standard RFID readers. Information can be stored concerning events that occur, without presence of an energy source (such as an RFID reader). At a later point this information can be retrieved using a standard RFID reader.

### BACKGROUND OF THE INVENTION

A passive Radio Frequency Identification (RFID) tag is an integrated circuit combined with an antenna structured such as to allow the RFID tag to be attached to an object to be tracked. The tag antenna picks up signals from an RFID reader and reflects the signal, usually with additional data encoded by modulation of the reflected signal (the additional data being a product code, a unique serial number, or other customized information).

A Radio Frequency Identification (RFID) system based on passive RFID tags has three parts: a) a scanning antenna, b) a transceiver connected to the scanning antenna, with a decoder to interpret the data (an RFID reader), and c) a transponder (the passive RFID tag) that has been programmed with information. The scanning antenna puts out radio-frequency (RF) signals. The RF radiation provides a means of communicating with the transponder (the passive RFID tag) and provides the passive RFID tag with the energy to communicate. Passive RFID tags do not need to contain batteries, and can therefore remain usable for very long periods of time. The scanning antennas can be permanently affixed to a surface. They can take whatever shape needed; for example, they could be built into a doorframe to accept data from persons or objects passing through. When a passive RFID tag passes through the field of the scanning antenna, it detects the activation signal from the scanning antenna. That “wakes up” the RFID chip, and it transmits the information on its microchip to be picked up by the scanning antenna. The information transmitted often consists solely of the unique ID number with which every RFID tag is provided. The antenna in an RFID tag is a conductive element that permits the tag to exchange data with the reader. Passive RFID tags can be small, inexpensive, and can be used in a wide variety of circumstances. In the case of passive LF and HF (low and high frequency) tags, the tags make use of coiled antennas that collect energy provided by the reader's carrier signal. When radio waves from the reader are encountered by a passive LF or HF RFID tag, the coiled antenna within the tag draws power from the reader's radio waves, energizing the circuits in the tag and then sends the information encoded in the tag's memory. UHF (ultra high-frequency) RFID tags make use of a method of communication called backscatter. Tags using backscatter technology reflect the RF reader's signal back to the reader, modulating the signal to transmit data. A common passive RFID tag can backscatter only the encoded identification (ID) or other customized information that was written in its memory without any connection to a specific external event.

There are specific applications involving RFID systems that are based on the sensing of external events or information with respect to the environment around the RFID tag. The sensed event or the environmental information is then generally converted into data to be written to non-volatile memory, either provided onboard by the RFID tags or added by the developer. Such applications typically use various electronic devices (CPU, memory, etc) in addition to the RFID tag itself. The electronic devices often have a processor and a bus, and are coupled to the RFID tag over the bus. The processor executes instructions to read information from and write information to the non-volatile memory of the RFID tag. Then an RFID reader device can read the information from the RFID tag. Other applications utilize information collected through the tracking of RFID tags and by identifying an alteration of physical attributes of the RFID tag (such as distance from the monitoring device or from another RFID tag). Such systems typically include RFID monitoring and RFID communications devices coupled to a local or remote database, which is updated consequent to the change in the physical attribute of the RFID tag. Still other RFID systems are directed to recognize physical attribute changes in the RFID tag where the attribute changes are indicated by the alteration of electrical characteristics associated with various sensors. Generally these latter devices either rely on on-board power provided by a battery to retain readings in some form of memory, or are read periodically by an RFID reader. These provisions are required to prevent the information measured from being lost as the environment changes. We stress the point that if measured information is not either stored in some way or read by an external reader, it will be lost.

There are several devices in the prior art which attempt to write external event-specific or environmental condition-specific information to a non-volatile memory of a passive RFID tag in order to allow an RFID reader to obtain the information. As examples we quote the following patent documents:

U.S. App. No. 2008/0143532 applied for by Murrah, discloses a method for tracking items having associated RFID tags, and for updating information based on the physical context of the items. An item having an associated radio frequency identification (RFID) tag is tracked. A change in a physical attribute of the item is detected. Information stored in the tag is updated based on the detected change. Information stored in a database may also be updated based on the detected change. A system for tracking an item having an associated RFID tag includes a monitor system and a RFID communication device. The monitor system is configured to detect a change in a physical attribute of the item. The RFID communication device is coupled to the monitor system and is configured to update information stored in the tag based on the detected change. The tracking system includes a network communication device coupled to the monitor module that is configured to update information stored in a database based on the detected change. It will be clear that this device requires either use of RFID with onboard memory, periodic reading by the monitor system, or both.

U.S. Pat. No. 7,366,806 issued to Milenkovski discloses a system including: a) a radio frequency identification (RFID) tag containing a non-volatile memory to store physical and logical attribute information; b) an electronic device associated with the RFID tag, the electronic device having a processor and a bus, and being communicatively coupled to the RFID tag over the bus, the processor to execute instructions to read information from and write information to the non-volatile memory of the RFID tag; and c) a RFID tag reading device to read information. The RFID tag-reading device reads information from the RFID tag when the electronic device associated with the RFID tag is powered off. This device requires both non-volatile memory and an onboard computer (processor and bus) which in general will require some form of power supply.

U.S. App. No. 2008/0042830 applied for by Chakraborty discloses a method for implementing a virtual sensor in an RFID tag reading system which includes an RFID reader and at least one RFID tag having tag memory in which sensor data is stored. In one embodiment, sensor data is initially read from the tag memory. The sensor data is then stored in sensor cache memory in the reader. Sensor data is accordingly read and stored at a predetermined interval. The sensor data in sensor cache memory is periodically updated, via predictive modeling software stored in, and executed by, the reader, to determine a present or future estimated value for the sensor data from observed changes in the data. Requests for sensor data are served from the cache memory instead of from the sensor itself. Both onboard memory and periodic reading are employed by this device.

U.S. App. No. 2005/0012616 applied for by Forster, discloses an RFID tag that includes a portion that has alterable characteristics. An RFID tag that includes a first portion and an inactivatable second portion, wherein the inactivatable second portion includes an antenna, which may be deactivated by contact with a suitable solvent. The solvent may be a substance, such as water, that dissolves at least part of the inactivatable second portion, such as a substrate, and/or a material placed upon the substrate. Another example is a tag which changes characteristics upon laundering. In this case an irreversible change occurs in the tag which obviates the need for conventional memory; information (a single bit) is stored in the device in the form of this irreversible change. It is clear however that readout of this information relies on the deactivation of the antenna portion of the device. This will prevent the user from continuing to enjoy the benefits of having tagged an object (tracking, inventory, etc) since the deactivated tag is now ‘invisible’. In fact it will not even be known if the tagged object is still onsite and has been deactivated (e.g. by becoming wet or being laundered), or simply has been removed from the site (e.g. stolen).

US patent application 20060290496A1 provides an integrated passive wireless chip diagnostic sensor system that can be interrogated remotely with a wireless device such as a modified cell phone incorporating multi-protocol RFID reader capabilities (such as the emerging Gen-2 standard) or Bluetooth, providing universal easy to use, low cost and immediate quantitative analyses, geolocation and sensor networking capabilities. The invention can be integrated into various diagnostic platforms and is applicable for use with low power sensors such as thin films, MEMS, electrochemical, thermal, resistive, nano or microfluidic sensor technologies. Applications of the invention include on-the-spot medical and self-diagnostics on smart skin patches, Point of Care (POC) analyses, food diagnostics, pathogen detection, disease-specific wireless biomarker detection, remote structural stresses detection and sensor networks for industrial or Homeland Security. Amongst the sensors listed are some that retain changed characteristics for a period of time, such as chemical sensors that change properties when wine turns or milk spoils. Thus these sensors do not necessarily require batteries and instead may keep the information about (for example) bad wine or milk until being read. However the device will require use of onboard or external memory locations to allow for transmission of sensed information, and the transmission protocol will most simply generally be based upon Gen 2 devices. These facts force the user to use more advanced devices than may be strictly necessary.

While all the aforementioned devices may be effective in the execution of the specific applications they are utilized for, they all have a number of drawbacks. Systems requiring onboard processing and/or memory are expensive and difficult to design, program and install and generally require battery power and/or periodic reading. The RFID systems disclosed that utilize RFID tags that are capable of responding to an external physical, chemical or electric forces, such as being covered by liquid, and that furthermore do not require battery power or memory still suffer from the drawback that the readout of sensed data is restricted to a primitive system of deactivating the tag when a given event occurs, thus preventing any further tracking of the tagged object, or use of more advanced Gen2 protocols requiring writing data to various user data locations on the RFID chip.

There is therefore a long-felt need for passive, battery-free and processor-free RFID tag which is small, simple, inexpensive, disposable, capable of sensing and recording an external event or events. Ideally such a device would be capable of transmitting the occurrence of the external event to an RF reader without additional supporting devices.

### SUMMARY OF THE INVENTION

The present invention concerns a passive radio frequency identification (RFID) tag device for external event monitoring and information transmittal to a radio frequency reader. The tag includes a sensor device for the monitoring of an external event coupled to or consisting of an irreversible switch, and a novel method for transmitting the switch state to an RFID reader device. In one embodiment of the device this transmission method consists of activating or deactivating one or more auxiliary RFID tags. In one simple embodiment the device is provided with a primary RFID tag and an auxiliary RFID tag. A single switch undergoes an irreversible state change due to e.g. being laundered, tampered with, heated beyond a certain temperature limit, or the like. Depending on the state of this switch, the device will transmit different information to the reader. For example the switch can in its first position deactivate the auxiliary RFID tag by shorting the ends of its antenna together. The RFID reader will then sense the ID of the primary tag. If laundering/tampering/heating or alike occurs, the switch is moved to its second position, where it shorts the primary tag and unshorts the auxiliary tag. Thus the RFID reader will read ID of the auxiliary tag. The sensed information (that the tag has been laundered/tampered with/heated) is provided to the reader through the specific ID that is transmitted. No modification of the RFID tags used is needed other than to allow deactivation of the auxiliary tag, thus maintaining the extreme low cost of the RFID tags which may even be primitive ‘Gen 2’ tags of the cheapest and most plentiful variety. Deactivation of an ID device can be as simple as disconnecting or shorting the antenna, allowing a particularly simple configuration wherein the switch is placed in the conduction path between the secondary RFID chip and antenna. Other than this, modification is necessary only in either the reader or in tracking software based on the reader's readings. If the primary ID is sensed, the event to be sensed (laundering in this example) has not occurred. If the auxiliary ID is sensed, the event to be sensed has occurred. Obviously further auxiliary tags can be supplied to provide further bits of sensed information.

It is an object of the present invention to provide a passive radio frequency identification (RFID) tag device located on an object for external event monitoring by an standard RFID reader, said tag comprising:
a) at least one sensor adapted to monitor at least one external event;
b) at least one switch responsive to said at least one sensor, said switches adapted to change state in accordance with said at least one external event detected by said at least one sensor;
c) an RFID module comprising at least one RFID tag in electrical comunication with said at least one switch;
wherein the operating states of said RFID tags are affected by the disposition of said switches, thereby conveying said switch state information from said tag device to said standard RFID reader, without use of stored energy.

It is a further object of the present invention to provide the RFID tag device wherein said operating states of said RFID tags are selected from a group consisting of: antenna shorted by a subset of said switches, and antenna not shorted by a subset of said switches.

It is a further object of the present invention to provide the RFID tag device wherein said operating states of said RFID tags consist of memory states.

It is a further object of the present invention to provide the RFID tag device, wherein said at least one sensor is selected from a group consisting of: a pressure sensing device, an attitude sensing device, lanyard device responsive to pulling, pressure-sensitive switch, adhesive strip responsive to the removal of a regular tag adhered thereto, electrical element with hysteresis, bimetallic strip, and bimetallic switch restrained from returning to its rest state by a ratchet mechanism.

It is a further object of the present invention to disclose a method for event monitoring by an standard RFID reader using a passive radio frequency identification (RFID) tag device located on an object comprising steps of:
a) providing at least one sensor adapted to monitor at least one external event;
b) providing at least one switch responsive to said at least one sensor, said switches adapted to change state in accordance with said at least one external event detected by said at least one sensor;
c) providing an RFID module comprising at least one RFID tag in electrical comunication with said at least one switch;
wherein the operating states of said RFID tags are affected by the disposition of said switches, thereby conveying said switch state information from said tag device to said standard RFID reader, without use of stored energy.

It is a further object of the present invention to disclose the aforementioned method wherein said operating states of said RFID tags are selected from a group consisting of: antenna shorted by a subset of said switches, and antenna not shorted by a subset of said switches.

It is a further object of the present invention to disclose the aforementioned method wherein said operating states of said RFID tags consist of memory states.

It is a further object of the present invention to disclose the aforementioned method wherein said at least one sensor is selected from a group consisting of: a pressure sensing device, an attitude sensing device, lanyard device responsive to pulling, pressure-sensitive switch, adhesive strip responsive to the removal of a regular tag adhered thereto, electrical element with hysteresis, bimetallic strip, and bimetallic switch restrained from returning to its rest state by a ratchet mechanism.

It is a further object of the present invention to disclose a method for monitoring an external event on an object by using a standard RFID reader comprising steps of
a. obtaining a passive radio frequency identification (RFID) tag device, said tag comprising:
   i. at least one sensor adapted to monitor at least one external event;
   ii. at least one switch responsive to said at least one sensor, said switches adapted to change state in accordance with said at least one external event detected by said at least one sensor;
   iii. an RFID module comprising at least one RFID tag in electrical comunication with said at least one switch;
wherein the operating states of said RFID tags are affected by the disposition of said switches, thereby conveying said switch state information from said tag device to said standard RFID reader, without use of stored energy and
b. locating said (RFID) tag device on said object

It is a further object of the present invention to disclose the aforementioned method wherein said operating states of said RFID tags are selected from a group consisting of: antenna shorted by a subset of said switches, and antenna not shorted by a subset of said switches.

It is a further object of the present invention to disclose the aforementioned method wherein said operating states of said RFID tags consist of memory states.

It is a further object of the present invention to disclose the aforementioned method wherein said at least one sensor is selected from a group consisting of: a pressure sensing device, an attitude sensing device, lanyard device responsive to pulling, pressure-sensitive switch, adhesive strip responsive to the removal of a regular tag adhered thereto, electrical element with hysteresis, bimetallic strip, and bimetallic switch restrained from returning to its rest state by a ratchet mechanism.

It is a further object of the present invention to disclose a method for event monitoring by an standard RFID reader using a passive radio frequency identification (RFID) tag device located on an object comprising steps of:
a) providing at least one sensor adapted to monitor at least one external event;
b) providing at least one switch responsive to said at least one sensor, said switches adapted to change state in accordance with said at least one external event detected by said at least one sensor;
c) providing an RFID module comprising at least one RFID tag in electrical comunication with said at least one switch;
wherein the operating states of said RFID tags are affected by the disposition of said switches, thereby conveying said switch state information from said tag device to said standard RFID reader, without use of stored energy.

It is a further object of the present invention to disclose the aforementioned method wherein said operating states of said RFID tags are selected from a group consisting of: antenna shorted by a subset of said switches, and antenna not shorted by a subset of said switches.

It is a further object of the present invention to disclose the aforementioned method wherein said operating states of said RFID tags consist of memory states.

It is a further object of the present invention to disclose the aforementioned method wherein said at least one sensor is selected from a group consisting of: a pressure sensing device, an attitude sensing device, lanyard device responsive to pulling, pressure-sensitive switch, adhesive strip responsive to the removal of a regular tag adhered thereto, electrical element with hysteresis, bimetallic strip, and bimetallic switch restrained from returning to its rest state by a ratchet mechanism.

### BRIEF DESCRIPTION OF THE DRAWINGS

The invention herein described, by way of example, with reference to the accompanying drawings, wherein;

FIG. 1 is a schematic semi-pictorial view of a first implementation-specific configuration of the passive RFID tag, in accordance with a preferred embodiment of the present invention;

FIGS. 2A and 2B are schematic, semi-pictorial views of a second implementation-specific configuration of the passive RFID tag, in accordance with a preferred embodiment of the present invention;

FIG. 3 is a schematic, semi-pictorial view of a third implementation-specific configuration of the passive RFID tag in accordance with a preferred embodiment of the present invention;

FIG. 4 is a schematic view of an embodiment of the present invention;

FIG. 5 is a schematic view of an embodiment of the present invention;

FIGS. 6A and 6B are a schematic views of an embodiment of the present invention;

FIG. 7 is another schematic view of an embodiment of the present invention;

FIG. 8 is a another schematic view of an embodiment of the present invention;

It should to be understood that the foregoing drawings and the description below, are provided primarily for purposes of facilitating understanding the conceptual aspects of the invention and various possible embodiments thereof; including what are now considered to be preferred embodiments. It is to be further understood that the embodiments described are for purposes of example only, and that the invention is capable of being embodied in other forms and applications than those described below.

### DETAILED DESCRIPTION OF THE PREFERRED EMBODIMENTS

In the following description, vaious aspects of the invention will be described. For the purposes of explanation, specific configurations and details are set forth in order to provide a thorough understanding of the invention. However, it will be also apparent to one skilled in the art that the invention may be practiced without specific details presented herein. Furthermore, well-known features may be omitted or simplified in order not to obscure the invention.

The term ‘plurality’ refers hereinafter to any positive integer e.g, 1, 5, or 10 or any other number.

The term ‘RFID’ hereinafter refers to radio-frequency identification or the system of object identification and tracking known as such.

The term ‘switch’ hereinafter refers to a mechanical, electrical, chemical, or other means of making and breaking electrical contact between two conductors.

The term ‘subset’ of a first group refers to a second group consisting solely of elements of the first group. The subsets of the group {Apple, Banana, Coconut} are {Apple, Banana, Coconut}, {Apple, Banana}, {Apple, Coconut}, {Banana,Coconut}, {Apple}, {Banana}, {Coconut}, reorderings of these groups, and the empty group { }.

An event-sensing technology in a passive radio frequency identification (RFID) tag is disclosed. The sensed event could be, for example a change in ambient light, pressure, movement, attitude, location, wetness, temperature and the like. The event could be caused by a human individual attempting to perform unauthorized manipulaton of the passive RFID tag. The passive RFID tag is supplied with an irreversible switch which changes state due to occurance of an external event by sensors or sensor-like components incorporated in the passive RFID tag. In one embodiment, when an external event is sensed by the sensors or the sensor-like components of the RFID tag, the state of a dedicated multi-point switch, contained in the RFID tag, changes. The dedicated multi-point switch could be a mechanical switch,electrical switch, or other switch.

This switch's state information is read by an RFID reader. In some embodiments, the state of the switch can change only once. For example, the switch may be simply a length of wire that is broken by removal of the tag from a substrate. Different states of the switch bring about the closing or opening of specific electronic circuits associated with the RFID tag for purposes of information storage and/or facilitating readout. In a simple example, a secondary RFID device is provided near the primary tag. This seconday device is activated by the opening of the switch, allowing a standard reader to register the opening of the switch while still tracking the tagged object. This may be accomplished for example by a length of wire that shorts the secondary antenna, deactivating it until the this length of wire is broken by tag removal from the substrate. If the RFID reader senses the continued response of the secondary RFID device, the switch is known to be in the ‘on’ state; if the RFID reader does not sense any response from the secondary RFID device, the switch is known to be in the ‘off’ state. This method allows the the tag to remain ‘visible’ (ie. trackable) since the primary RFID device remains operative and responsive to RFID reader queries, while allowing the switch state information to be sent. It should be appreciated that this system ‘piggybacks’ on currently used, simple RFID systems such as ‘generation 1’ or ‘generation 2’ systems. This is a nontrivial acheivement since the ‘generation 1’ tags are provided with unique IDs and no information other than this simple unique ID is ever transmimtted by any generation 1 tag.

For example, one embodiment of the invention serves as an Electronic Article Surveillance (EAS) device. A shoplifter may be tempted to forcibly remove an RFID tag attached to an article of merchandise (in order to prevent the activation of an alarm raised by an RFID reader when a shoplifter carries the unpaid-for article past an RFID portal at the store exit). In this case a sensor-like component of the RFID tag can be used to change state of a switch, which for example no longer conducts when taken off the article of merchandise. The new alignment of the switch will operate an alternative electric circuit in the RFID tag that empowers the antenna of a secondary RFID tag, or replaces one tag id with another. The appearance of the secondary RFID signal serves to indicate that the tag has been forcibly tampered with.

In another example, the external event could be an attempt of a customer to forcibly remove a suitably modified price tag from an article of merchandise. The attempt will cause the pulling of a lanyard connected to an RFID tag. As above, the pulling of the lanyard will change the status of the RFID tag by opening an electric circuit that will enable a secondary RFID tag. Consequently, in response to an interrogation signal of a nearby RFID reader, removal attempt can be sensed by the RFID reader in the form of appearance of the secondary RFID signal. In another example, the external event could be an attempt of a customer to forcibly remove an adhesive label from an article of merchandise.

In one embodiment of the invention the passive RFID tag is used for unattended data collection. The tag monitors external events to provide for event documentation. In one embodiment the sensor is a device that undergoes an irreversible change when a certain physical condition to be detected occurs. For example, in one embodiment of the device, the sensor consists of a bimetallic strip engaged by a ratchet. As is well known a thin bimetallic strip will deform in response to temperature change in a predictable way. The bimetallic switch is used to open or close an electrical contact, depending upon its deformation (and therefore depending upon the temperature). By means of a ratchet or other one-way mechanism the bimetallic strip and/or switch contact is kept from returning to its original state. In this way if a certain predetermined temperature is exceeded, the device will change state irreversibly. To read out this information, a secondary RFID tag is provided whose antenna is connected through the aforementioned switch. When the switch changes state, the secondary RFID is either activated or deactivated, and the appearance or disappearance of this signal indicats that the predetermined temperature has been exceeded. Such a device will find obvious use for example in the tracking and quality control of objects that must be kept within a given temperature range such as meat for consumption, organs for transplant, eggs during incubation, plants in a greenhouse, etc. It is emphasized that the system ‘remembers’ that a certain event has occurred (in this case a temperature excursion above a certain setpoint) without batteries or standard nonvolatile memory.

It will be obvious to one skilled in the art that certain generalizations of this system are possible. For example, additional bits of information may be encoded by additional auxiliary RFID tags. Thus one auxiliary tag may be switched on to encode whether the temperature of an object has exceeded 0° C., a second tag may be switched on to encode whether the temperature has exceeded 10° C., a third tag may be switched on to encode whether the object has been subjected to violent acceleration, etc. In this way more detailed information may be encoded while still using the simplest possible RFID tags and while still using the primary RFID tag to track the object.

It will be further obvious to one skilled in the art that various other physical phenomena may be exploited to created irreversible switches. For example, chemical reactions may be exploited on a strip of material impregnated with an ionic or electronic conductor, whose conductivity will be modified by the degree of reaction experienced by the strip. When exposed for example to a certain gas, the material of the strip reacts and its conductivity drops to 1/100 of its original value, thus effectively connecting the antenna of an auxiliary RFID tag.

It is within the scope of the invention that a 2^{nd} generation RFID device be used wherein the information sensed is used to close switches that affect the user-addressable memory of the device.

It is within the scope of the invention that UHF be used for the RFID process. This is in contrast to the majority of RFID systems in use for store security systems today, and has the advantage that the range within which tags will respond to a query is larger for UHF than for lower frequencies.

It is within provision of the invention that information be written to data areas of RFID chips provided with such data areas. The energy for these operations is preferably obtained from the carrier wave of an RFID reader; this way, the write operation does not require a battery or other onboard power source. The switch or switches provided for sensing of external data may be so configured that specific data are written to specific addresses in the data areas of the RFID chip. When read, this information will transmit the measured data to the RFID reader. By this means the use of auxiliary RFID devices to convery information is rendered unecessary.

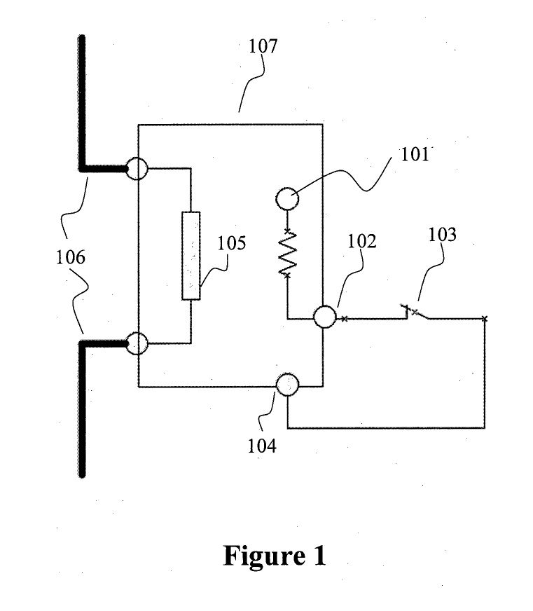

We refer now to FIG. 1 showing a basic embodiment of the device. The RFID tag 107 contains within it an antenna modulation section 105 and the antenna 106. In many tags the operation of the modulation section can be modulated for instance by means of a voltage present within the chip, for example at point 101. The chip is provided with leads 102,104 for the purpose of affecting this voltage. By opening or closing external switch 103, the voltage at point 101 may be altered and thereby the information transmitted by the antenna 106 upon interrogation may be altered.

In certain embodiments of the invention, the switch 103 is broken by external means such as tag attachments, lanyards, temperature sensors, pressure sensors, and the like. In this way the tag will be able to transmit (for instance) that it has been tampered with, has exceeded a certain temperature, or the like. These embodiments will be more fully detailed below.

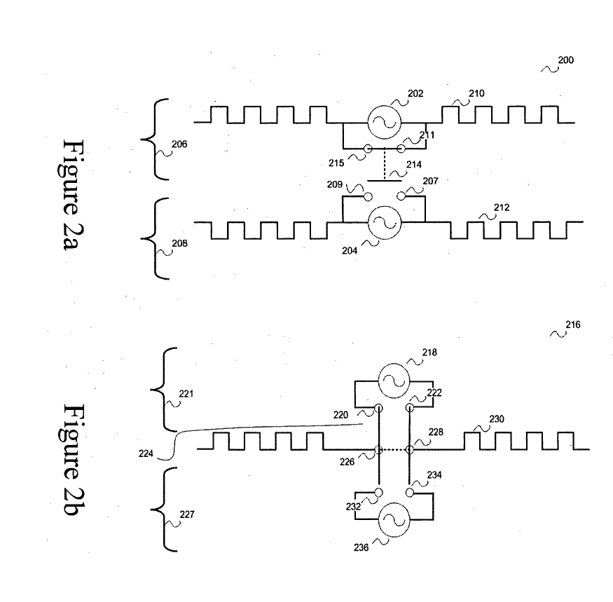

Referring now to FIG. 2A the RFID tag 200 includes a first passive RFID device 206 and a second passive RFID device 208. The devices 206, 208 have RFID antennas 210,212. A switch 214 has two positions. In its ‘up’ position it connects points 215,211 of the first device 206. This will have the effect of disabling the antenna 210, as now the two sides of the antenna are shorted together. In the ‘down’ position, switch 214 connects points 207,209 thereby neutralizing the antenna 212 of the second RFID device 208. By means of the position of the switch 214, one of two ID's are broadcast, either that of device 206 or that of device 208. It will be appreciated that in this way a single bit of information, namely the position of the switch 214, can be broadcast. Note that no use of memory devices has been made, and the simplest RFID chips such as Generation 1 chips can be used with this method to transmit information.

The switch can be activated for instance by a seat belt buckle; when the seatbelt is fastened the switch opens the first RFID tag 206 and shorts the second tag 208, causing the unique ID of tag 206 to be broadcast in response to reader queries. When the seatbelt is unfastened, the switch activates the second RFID tag 208 and shorts the first tag 206, causing the second tag's unique ID to be broadcast instead of the first. Thus the ID broadcast is dependent on the state of the belt buckle. If for instance state law required such devices in all cars, traveling police could check from a distance if the belt buckles were fastened or not. Obviously any two-state switch can be used for the switch element 214. For example, the state of pressure sensors, temperature sensors, device interlocks, and other devices can be transmitted using the system described above, as will be obvious to one skilled in the art.

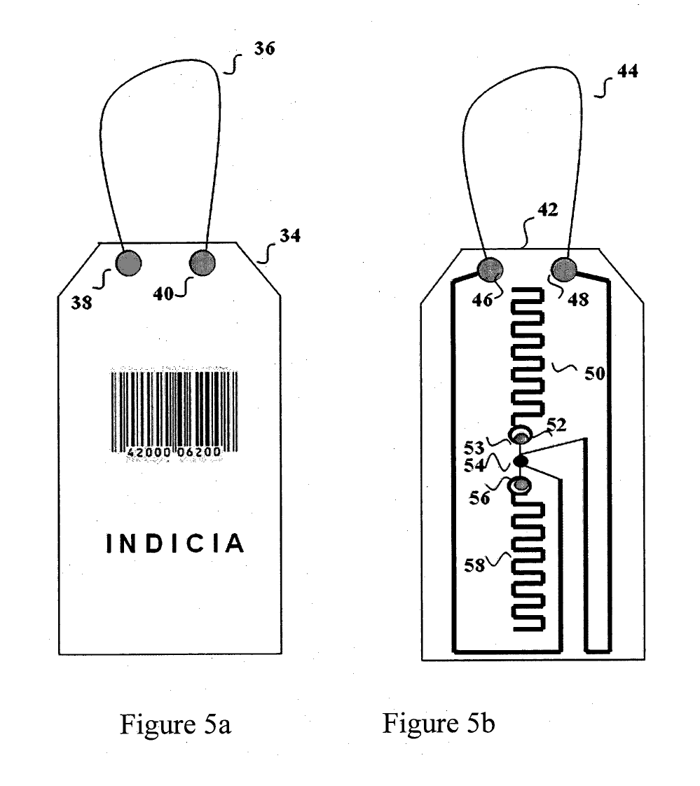

FIG. 2A shows the internal view of the RFID tag 34 (FIG. 5A) that looks superficially like a regular price tag having various indicia printed on it and a lanyard 44 attached to it via circular openings 46,48. The price tag 34 in FIG. 2A shown like this to a casual on-looker or a potential shoplifter would seem to be an unremarkable price tag attached to an article of merchandise. FIG. 2B shows that tag 34 is revealed to be an RFID tag. With the cover removed the internal components and arrangements of the RFID tag 42 are visible. Lanyard 44 is inserted through openings 46 and 48 such that it creates a mechanical loop that is connected to a switch 53. In this implementation-specific configuration the lanyard is used as a sensor-like device. In normal use the multi-point switch is closed and the secondary RFID 220 is connected to its antenna 230. However when the lanyard 44 is pulled in either direction, the switch will be pulled by the lanyard 44 such as to open the circuit and detach the secondary RFID 220 from its antenna 230, rendering it inactive. The absence of this secondary signal is interpreted as an attempt to tamper with the device. Thus for example RFID readers may be put in the vicinity of dressing rooms. Attempts to tamper with the price tag lanyard 44 results in the loss of secondary RFID 220 and raises an alarm. The existence of primary RFID 210 is important since it alerts the reading system that secondary RFID 220 should be expected. The RFID reader near the dressing rooms would be programmed (or connected to a computer that is programmed) with a series of primary-secondary RFID pairs. When a primary is detected, the corresponding secondary is required; if the corresponding secondary is missing, an alarm is raised. As above, the system can be modified to cause activation of the secondary antenna instead of deactivation by a trivial reconfiguration of the circuit.

FIG. 2B shows an alternative embodiment of the current invention. In FIG. 2A one or the other of two RFID antenna are shorted; in FIG. 2B, a single antenna is connected to either one of two RFID chips. The RFID device 216 of Fig. has a single antenna 230. This antenna is connected to one of the two RFID chips 218, 236 by means of connecting or disconnecting the antenna 230 to the chip. When points 220,222 are connected to the antenna by means of a switch, the upper chip 218 responds when queried. On the other hand when points 232,234 are connected to the RFID chip 236, the lower chip 236 is the one that will respond when queried. The switch as shown is in essence a two-state two-pole switch that simultaneously connects both sides of antenna 230 to one of two chips 218 or 236.

In one alternative embodiment, the secondary RFID could for instance always be provided with an ID that is one higher than the primary RFID, allowing one to predict the expected secondary RFID number upon detection of the primary RFID One skilled in the art will be aware that many variations upon this scheme are possible, such as activating instead of deactivating the secondary RFID upon tampering, making the secondary ID number an arbitrary function of the first ID number, using several or no primary and/or secondary RFID units, and the like.

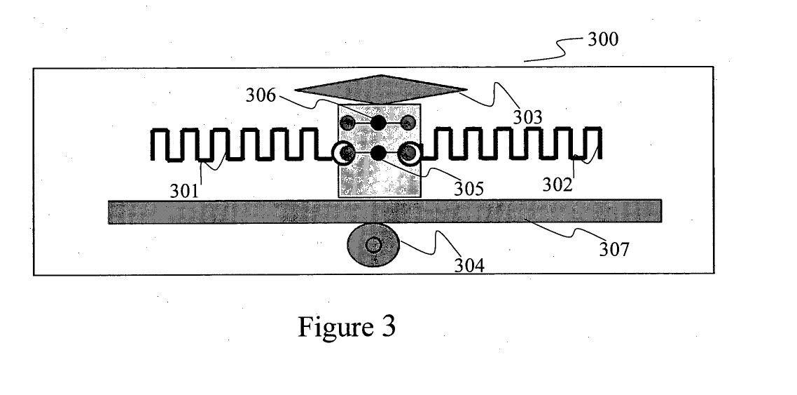

In FIG. 3 an embodiment is shown that uses several RFID chips sharing a single antenna. The antenna has sides 301, 302. These are connected by means of a two-position switch to one of the two RFID chips 305, 306. A spring 303 applies pressure to the breakable bar 307, and a pin 304 is provided. In normal use the pin 304 pierces an article of merchandise such as clothing, firmly attaching the label 300 to the article. When the pin is connected the two-position switch will be in the lower position, effectively connecting the antenna parts 301, 302 to the RFID chip 305. This RFID chip is provided, as all RFID chips, with a unique ID. When tampering occurs, the spring 303 is so disposed as to break the breakable member 307 and put the switch into the top position, such that the second RFID chip 306 is now connected to the antenna parts 301, 302. In this way both theft and tampering acan be detected. An RFID reader near the exit looks for the ID of chip 305; if this ID is found then the tag has not been removed by store personnel, and the item is being stolen. If ID 306 is found, the item has been tampered with. Additional readers can be located in the dressing rooms and other areas of the store to alert the personnel that an item is being tampered with.

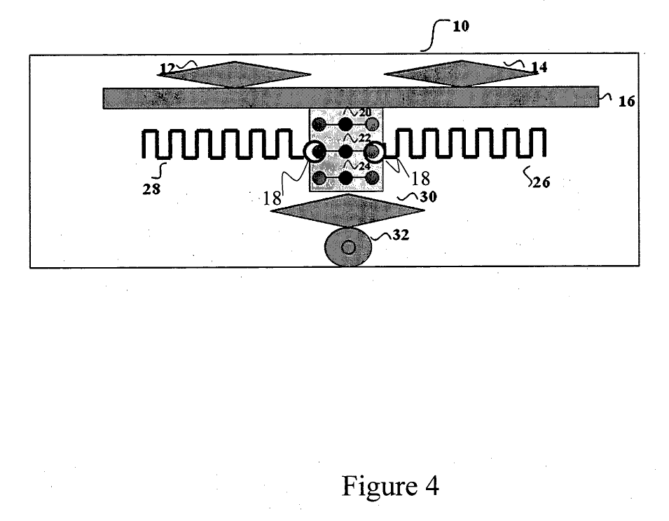

In FIG. 4 an embodiment is shown that uses several RFID chips sharing a single antenna. A passive RFID device is provided that transmits status or context information to an RFID reader. Tag 10 contains a first spring 12, a second spring 14, a third spring 30, a breakable or collapsible bar 16, a multi-point switch 18, antenna sides 26 and 28, and a tack device 32. The status of the RFID tag 10 is set in one of three states, in accordance with the external events sensed by the RFID tag 10. Tag 10 includes a multi-point switch 18 having three distinct positions, that put the antenna 26,28 into contact with one of three RFID chips, 20, 22 and 24. The position of the multi-point switch 18, into position 20, 22 or 24, is set in accordance with external events. For purposes of example, we describe a tag to be used on an article of clothing in a clothing store as a security and anti-tampering device. In one state, the device alerts a reader at the store exit that device has not been purchased. In a second state, the device alerts a reader near the dressing rooms and/or racks that the device is being tampered with. In the third state, the device indicates that it has been purchased and has not been tampered with, and may therefore be removed from the store.

This is accomplished as follows. A tack device 32 puts the switch into middle position 22 when the tack 32 is in place. Thus the ID of the middle RFID device 22 is transmitted when the device is queried by an RFID reader. In this position the device will raise an alarm if a reader by the store exit detects the ID of device 22. After purchase, however, the tack 32 is removed by shop personnel in a pre-defined manner, typically using specialized equipment. The removal of the tack 32 puts multi-point switch into the lower position 24. As a result the antenna 26,28 will be connected to a different RFID circuit 24. When carrying the article of manufacture through an interrogation field by the store exit with the RFID tag 10 removed, the RFID reader will get a ‘non-theft’ response from RFID tag. In such a situation no alarm will be raised. Alternatively the tag may be removed altogether from the piece of clothing and attached to another. When shop personnel re-attach the RFID tag 10 to another article of merchandise the tack 32 is inserted again, such as to set the multi-point switch 18 back to the ‘armed’ position 22. The antenna 26,28 will again be connected to the first electric circuit and an attempt to carry the article of manufacture with the RFID tag 10 attached through the RFID portal will result in the raising of the alarm by the RFID reader.

The third position of the switch 20 is used to detect tampering. Pressure on the housing of the tag 10 is sensed by a pressure sensor comprising a first, a second, and a third spring 12, 14 and 30, respectively, and a breakable or collapsible bar 16. An attempt to remove the RFID tag 10 forcibly from an article of manufacture by a shoplifter in an area unmonitored by the shop personnel, such as private rooms, dressing rooms and the like will apply pressure to the RFID tag 10 housing, and will typically deform it. The deformation of the housing would also deform the internal structure of the tag 10 and create an external pressure on the first, second and third springs 12, 14 or 30 respectively. The pressure applied to the springs 12, 14 or 30 will be transferred to the breakable rod 16. The rod 16 is adapted to be broken or to be collapsed when a certain pressure is applied to it through first, second and third springs 12, 14 and 30, respectively. As a result the multi-point switch 18 will be set to its top position 20 and therefore the RFID tag 10 will transmit a third ID when queried. This ID is recognized by the RFID reader as indication that tampering has occurred. In accordance with the location of the interrogation field, such as an isolated area of the shop which is discreetly supervised by a hidden RFID reader device within the department store, an alarm could be raised to warn the shop employees to an attempt of forcibly removing the RFID tag 10 from an unpaid-for article of merchandise in the premises. It will be readily understood that in other embodiments tag 10 could be equipped with a plurality of other sensors or sensor-like devices adapted to monitor, to sense and to recognize a variety of external events and indicate the occurrence of the events in a pre-defined manner.

We refer now to FIGS. 5A and 5B. The clothing tag 34 is provided with a hidden security device. The outer layer 34 conceals the hidden inner layer 42. FIG. 5A shows the external view of the RFID tag 34 that looks superficially like a regular price tag having various indicia printed on it and a lanyard 36 attached to it via a first circular opening 38 and a second circular opening 40. The price tag 34 in FIG. 5A shown like this to a casual on-looker or a potential shoplifter would seem to be an unremarkable price tag attached to an article of merchandise in a known manner. FIG. 5B shows that with the cover removed tag 42 is revealed to be an RFID tag. With the cover removed the internal components and arrangements of the RFID tag 42 can be easily discerned. Lanyard 44 is inserted through openings 46 and 48 such that it creates a mechanical loop that is connected to the RFID chip 54. In this implementation the lanyard is used as a sensor-like device. In a normal state the RFID chip 54 sees a short closed by the lanyard. This short can be used either to change the internal state of the chip or as before to short the antenna halves 50,58 together. In the case of a shorted antenna, the tag will not respond to a challenge of an RFID reader in this state. However when the lanyard 44 is pulled in either direction, the multi-point switch 34 will be pulled by the lanyard 44 such as to cause an open circuit at the RFID chip, or to break the short circuit between antenna halves 50,58. Thus, when an attempt is made to unlawfully remove the RFID tag 42 by pulling the lanyard 44 in either direction, the RFID tag will now respond to interrogation by an RFID reader, which is interpreted as the occurrence of tampering. Thus, when tampering has occurred, the reception of the signal will cause an alarm to be sounded or otherwise indicated. It would be easily perceived that the structure of the RFID tag 42, the components and interconnections thereof could differ in other preferred embodiment of the invention. For example, other type of activating devices could be used. The different electronic circuits could share common circuit components interconnections and wiring arrangements. The indication of status transmitted by the RFID tag 42 to the RFID reader could be based on various electrical characteristics, such as the frequency of a frequency-modulated signal. For example, use could be made of two or more RFID tags optionally connected via a switch. The RFID tag 42 could have two antennas where a first one could respond to a certain type of interrogative signal from a specific RFID reader while a second one could respond to another type of interrogative signal from a specific RFID reader. RFID tag 42 could have a microchip containing a volatile memory block for storing identification of the tag 42 and a non-volatile memory block for storing varied information, for example, the date and time of the removal attempt and the like.

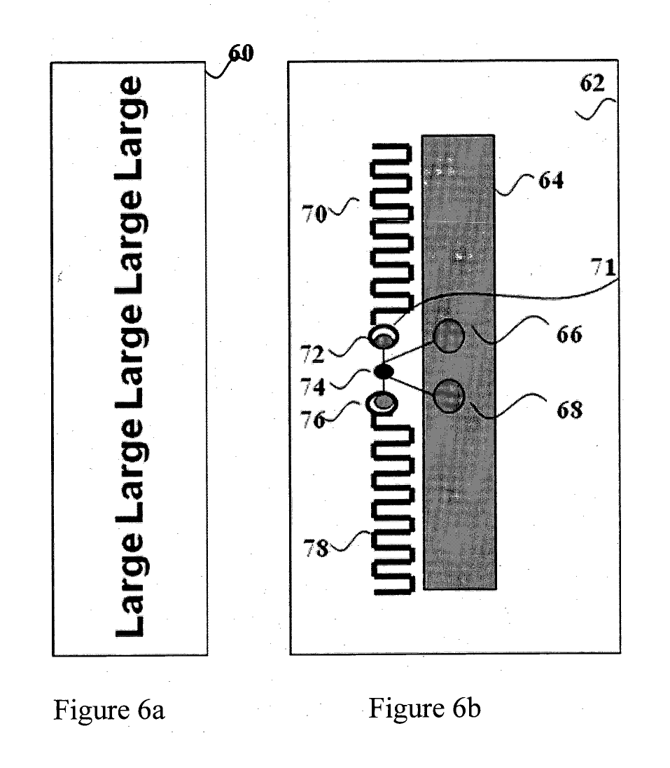

Reference is now made to FIGS. 6A and 6B. In this embodiment a peel-off tag is used that is activated when the tag is peeled off. The passive RFID tag 62 is provided with an adhesive label 60 (FIG. 6A) attached to an article of manufacture. Label 60 includes indicia, such as price of the article, size of the article (small, medium, large), and the like. The label 60 in FIG. 2A shown like this to a casual on-looker or a potential shoplifter would seem to be an unremarkable label attached to an article of merchandise adhesively. It would seem to be that the unauthorized removal of label 60 from the article of manufacture is a simple no-risk procedure. FIG. 3B shows an RFID tag 62 that is disposed below the label 60. The label 60 adheres to the adhesive tag 62 and conceals its contents, while the tag 62 adheres to an article of manufacture. The adhesion of RFID tag 62 to the article of merchandise is stronger than the adhesion of label 60 to the tag 62. Thus, when label 60 is removed from the article of manufacture by pulling off label 60, the adhesive area 64 in RFID tag 62 is revealed. The adhesive area 64 is attached to a circuit composed of pads 66,68 that are in elecrical communication with the chip 74. The connection to the chip may either affect the internal state of the chip, for example by setting a memory state, or b shorting the antenna sides 70,78. The underside of the label 60 is made conductive. Thus when the label 60 is in place, it maintains an electrical short between points 66,68 and hence either affects the chip memory location or shorts the antenna, altering the RFID signal or preventing RFID signals from being sent altogether. Consequent removal of label 60 removes the short between pads 66,68 and therefore the RFID device will now either respond to interrogation by an RFID reader with a different address, or begin responding altogether. As a result an alarm may be raised in a specific form, such as visually or aurally, that indicates to the shop personnel that an attempt was made to remove label 60 from an article of manufacture. It would be easily perceived that the structure of the RFID tag 62, the components and the interconnections therein could differ in other preferred embodiment of the invention. For example, other type of activating devices could be used. The different electronic circuits could share common circuit components interconnections and wiring arrangements. The indication of external event transmitted by the RFID tag 62 to the RFID reader could be based on various electrical characteristics such as frequency. For example, use could be made of two or more RFID tags optionally connected via a multi-point switch. The RFID tag 62 could have two antennas where a first one could respond to a certain type of interrogative signal from a specific RFID reader while a second one could respond to another type of interrogative signal from a specific RFID reader. RFID tag 62 could have a microchip containing a volatile memory block for storing identification of the tag 42 and a non-volatile memory block for storing varied information, for example, the date and time of the removal attempt and the like.

An alternative embodiment lies in the use of this switch to broadcast a stream of bits. By using an electronic switch instead of a mechanical switch, a bitstream can be encoded in the switching between first and second IDs. This could be useful for an extremely low-cost sensor, since only two RFID tags are required. The sensor could for instance use a PWM signal proportional to a physical measurement (e.g. of temperature, humidity, etc). This PWM signal would be used to control the switch. The ratio of the time period during which the first ID is broadcast to the period during which the second is broadcast encodes the measurement, which may be read by a standard RFID reader with appropriate modifications. This embodiment however may require a power source in order to operate the switch and/or sensor. To avoid this, the device can perform switching during periods of interrogation by use of the energy broadcast by the reader.

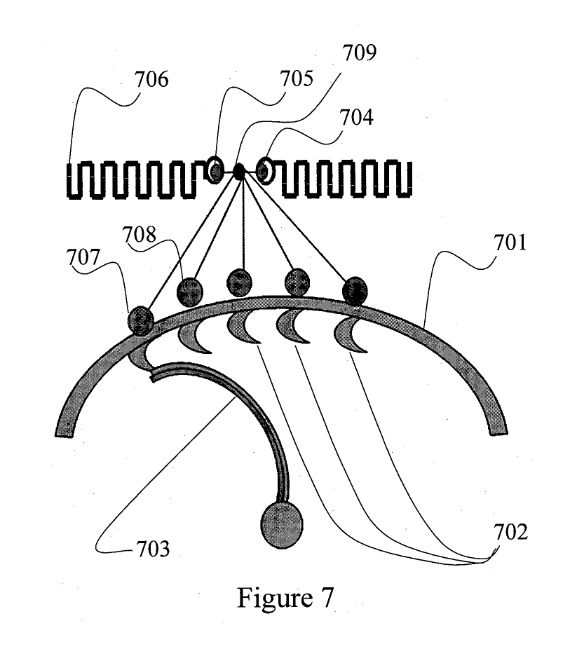

Another example of a switch that can be used in conjunction with the instant invention is shown in FIG. 7. Here a bimetallic strip 703 is used to sense temperature. As is well known such a strip will bend predictably at a given temperature, reaching the deflection shown in the figure e.g. only at 20° C. By means of ratchet device 701, the strip is kept from returning to its original state if given increments of temperature are ever reached. In the position shown, the strip connects point 709 with the RFID chip. This connection changes the internal state of the RFID chip 709, for example by setting the value in a given memory location to ‘0’. Similary, contact with point 708 would write a ‘0’ to a different memory location of the device. Thus the state of the RFID chip depends on whether the device has ever been exposed to certain temperatures, for example in increments of 5° C. This type of switch can be used in conjuction with the previous embodiments to allow an RFID reader to discover if a given tag has ever reached 20° C. This will find obvious use e.g. in such areas as meat shipping industries, blood supplies, etc. By putting such tags (which we stress are the cheapest possible type, not requiring even Gen 2 functionality, and at this point sold in bulk for 5 cents US) on pieces of meat, bags of blood plasma, pharmaceuticals, or any other temperature sensitive objects, one can verify easily and cheaply whether a given object has reached a given setpoint of temperature. Obviously this idea can be extended to position sensors, pressure sensors, attitude sensors, etc.

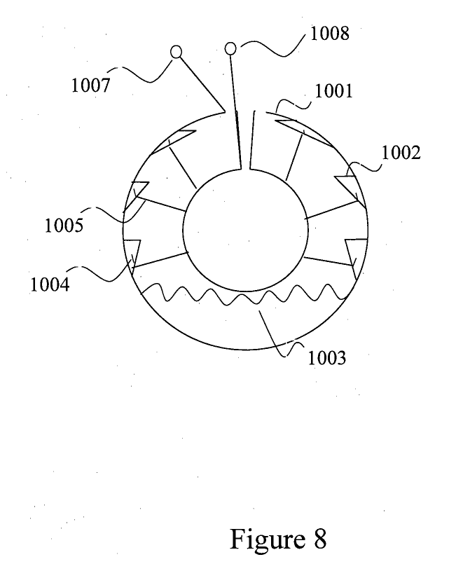

An example of an attitude sensor, or ‘tip sensor’ is shown in FIG. 8. This sensor is placed on items that must remain upright, and the sensor is placed as shown such that the liquid 1003 remains in the bottom of the device. The liquid 1003 is provided with some degree of conductivity, as in a saline solution. This liquid will fall into the liquid traps 1002 when the tip sensor 1001 rotates with respect to the direction of gravity. The ionic conductivity of the solution serves to close the circuit comprised of wires 1004, insulated conductors 1005, and the wall of the device. This will cause a degree of conductivity to be introduced between leads 1007 and 1008, which as in the examples before can be used to connect or disconnect an auxiliary RFID device. Due to the geometry of the traps, even if the device returns to its original position, some liquid remains in the traps to keep the circuit(s) closed. A plurality of such switches is shown to allow sensing of various angles.

It shall be readily perceived that although the above description and the above graphical presentation of the RFID tag of the present invention focuses on certain external events, such as pressure, attitude or temperature, in other embodiments of the invention the external event could be any physical environmental force that occurred close enough to the the sensors associated with the RFID tag to be able to sense it.

A possible order of operation for another embodiment of the current invention would be the operation of an RFID tag with a three way switch. If the tag is on, a switch will be thrown into position ‘A’ which opens a conduction path for a green or GO LED to shine when interrogated by an RFID reader. Alternatively, if the device is provided with onboard power, the green or GO LED may be turned on continuously. If the tag is not on then one of two remaining switch states is chosen, B or C. If an external event to be sensed has occurred, the switch is thrown into state B and a different colour (blue) LED is activated either during interrogation or otherwise. If the external event to be sensed has not occurred then a yet different colour (red) LED is put into conduction in the same fashion.

1. A passive radio frequency identification (RFID) tag device located on an object for external event monitoring by an standard RFID reader, said tag comprising:
a. at least one sensor adapted to monitor at least one external event;
b. at least one switch responsive to said at least one sensor, said switches adapted to change state in accordance with said at least one external event detected by said at least one sensor;
c. an RFID module comprising at least one RFID tag in electrical comunication with said at least one switch;
wherein the operating states of said RFID tags are affected by the disposition of said switches, thereby conveying said switch state information from said tag device to said standard RFID reader, without use of stored energy.

2. The RFID tag device of claim 1 wherein said operating states of said RFID tags are selected from a group consisting of: antenna shorted by a subset of said switches, and antenna not shorted by a subset of said switches.

3. The RFID tag device of claim 1 wherein said operating states of said RFID tags consist of memory states.

4. The RFID tag device of claim 1, wherein said at least one sensor is selected from a group consisting of: a pressure sensing device, an attitude sensing device, lanyard device responsive to pulling, pressure-sensitive switch, adhesive strip responsive to the removal of a regular tag adhered thereto, electrical element with hysteresis, bimetallic strip, and bimetallic switch restrained from returning to its rest state by a ratchet mechanism.

5. The RFID tag device of claim 1 wherein said operating states of said RFID tags are selected from a group consisting of: antenna shorted by a subset of said switches, and antenna not shorted by a subset of said switches.

6. The RFID tag device of claim 5 wherein said operating states of said RFID tags consist of memory states.

7. The RFID tag device of claim 1, wherein said at least one sensor is selected from a group consisting of: a pressure sensing device, an attitude sensing device, lanyard device responsive to pulling, pressure-sensitive switch, adhesive strip responsive to the removal of a regular tag adhered thereto, electrical element with hysteresis, bimetallic strip, and bimetallic switch restrained from returning to its rest state by a ratchet mechanism.

8. A method for monitoring an external event on an object by using a standard RFID reader comprising steps of
a. obtaining a passive radio frequency identification (RFID) tag device, said tag comprising:
i. at least one sensor adapted to monitor at least one external event;
ii. at least one switch responsive to said at least one sensor, said switches adapted to change state in accordance with said at least one external event detected by said at least one sensor;
iii. an RFID module comprising at least one RFID tag in electrical comunication with said at least one switch;
wherein the operating states of said RFID tags are affected by the disposition of said switches, thereby conveying said switch state information from said tag device to said standard RFID reader, without use of stored energy and
b. locating said (RFID) tag device on said object

9. The method according to claim 8 wherein said operating states of said RFID tags are selected from a group consisting of: antenna shorted by a subset of said switches, and antenna not shorted by a subset of said switches.

10. The method according to claim 9 wherein said operating states of said RFID tags consist of memory states.

11. The method according to claim 8, wherein said at least one sensor is selected from a group consisting of: a pressure sensing device, an attitude sensing device, lanyard device responsive to pulling, pressure-sensitive switch, adhesive strip responsive to the removal of a regular tag adhered thereto, electrical element with hysteresis, bimetallic strip, and bimetallic switch restrained from returning to its rest state by a ratchet mechanism.

12. A method for event monitoring by an standard RFID reader using a passive radio frequency identification (RFID) tag device located on an object comprising steps of:
a. providing at least one sensor adapted to monitor at least one external event;
b. providing at least one switch responsive to said at least one sensor, said switches adapted to change state in accordance with said at least one external event detected by said at least one sensor;
c. providing an RFID module comprising at least one RFID tag in electrical comunication with said at least one switch;
wherein the operating states of said RFID tags are affected by the disposition of said switches, thereby conveying said switch state information from said tag device to said standard RFID reader, without use of stored energy.

13. The method according to claim 12 wherein said operating states of said RFID tags are selected from a group consisting of: antenna shorted by a subset of said switches, and antenna not shorted by a subset of said switches.

14. The method according to claim 13 wherein said operating states of said RFID tags consist of memory states.

15. The method according to claim 12, wherein said at least one sensor is selected from a group consisting of: a pressure sensing device, an attitude sensing device, lanyard device responsive to pulling, pressure-sensitive switch, adhesive strip responsive to the removal of a regular tag adhered thereto, electrical element with hysteresis, bimetallic strip, and bimetallic switch restrained from returning to its rest state by a ratchet mechanism.
